(19) United States
(12) Patent Application Publication
(10) Pub. No.: US 2025/0250839 A1
(43) Pub. Date: Aug. 7, 2025

(54) MECHANICAL CHECK ON LINEAR DRIVE ACTUATOR

(71) Applicant: MAGNA CLOSURES INC., Newmarket (CA)

(72) Inventors: Ryan HERMAN, Newmarket (CA); Michael BAYLEY, Newmarket (CA); Darren NAVIN, Newmarket (CA)

(21) Appl. No.: 19/043,497

(22) Filed: Feb. 2, 2025

Related U.S. Application Data
(60) Provisional application No. 63/549,215, filed on Feb. 2, 2024.
(60) Provisional application No. 63/557,735, filed on Feb. 26, 2024.

(51) Int. Cl. E05F 15/622; E05F 15/40; E05F 15/79

(52) U.S. Cl. CPC E05F 15/622; E05F 15/40; E05F 15/79; E05Y 2201/224; E05Y 2201/71; E05Y 2900/531

(57) ABSTRACT

A powered actuator for a closure of a vehicle includes an electric motor configured to rotate a driven shaft. A linear actuator is configured to be coupled to one of a body or a closure of the vehicle for moving the closure between a fully closed position and a fully open position. The linear actuator having an extensible member and a nut. A cover is provided for at least partially enclosing the extensible member and the nut. At least one friction feature is fixed to at least one of the extensible member and nut, and at least one fixed friction feature is fixed to the cover, wherein the at least one friction feature fixed to the at least one of the extensible member and nut contacts the at least one fixed feature fixed to the cover to releasably hold the closure between the fully closed position and the fully open position.

### CROSS-REFERENCE TO RELATED APPLICATIONS

This application claims the benefit of U.S. Provisional Application Ser. No. 63/557,735, filed Feb. 26, 2024, and of U.S. Provisional Application Ser. No. 63/549,215, filed Feb. 2, 2024, both of which are incorporated herein by reference in their entirety.

### FIELD

The present disclosure relates to a linear actuator for a vehicle closure. More specifically, the present disclosure relates to a linear actuator assembly for a vehicle closure member.

### BACKGROUND

This section provides background information related to the present disclosure which is not necessarily prior art.

Closure members of motor vehicles may be mounted by one or more hinges to the vehicle body. For example, passenger doors may be oriented and attached to the vehicle body by the one or more hinges for swinging movement about a generally vertical pivot axis. In such an arrangement, each door hinge typically includes a door hinge strap connected to the passenger door, a body hinge strap connected to the vehicle body, and a pivot pin arranged to pivotably connect the door hinge strap to the body hinge strap and define a pivot axis. Such swinging passenger doors (“swing doors”) may be moveable by power closure member actuation systems. Specifically, the power closure member system can function to automatically swing the passenger door about its pivot axis between the open and closed positions, to assist the user as he or she moves the passenger door, and/or to automatically move the passenger door in between closed and open positions for the user.

Typically, power closure member actuation systems include a power-operated device such as, for example, an electric motor and a rotary-to-linear conversion device that are operable for converting the rotary output of the electric motor into translational movement of an extensible member. In many arrangements, the electric motor and the conversion device are mounted to the passenger door and the distal end of the extensible member is fixedly secured to the vehicle body. One example of a power closure member actuation system for a passenger door is shown in commonly-owned International Publication No. WO2013/013313 to Scheuring et al. which discloses use of a rotary-to-linear conversion device having an externally-threaded leadscrew rotatively driven by the electric motor and an internally-threaded drive nut meshingly engaged with the leadscrew and to which the extensible member is attached. Accordingly, control over the speed and direction of rotation of the leadscrew results in control over the speed and direction of translational movement of the drive nut and the extensible member for controlling swinging movement of the passenger door between its open and closed positions.

A high-resolution position sensor, such as a magnet wheel and a Hall effect sensor, may be used to accurately measure a position in a power closure actuation sensor. However, such high-resolution sensors can be adversely affected by electromagnetic (EM) interference, such as may be generated by an EM brake.

Closure member systems typically include a door check feature, provided separately from the rotary-to-linear conversion device, to facilitate releasably maintaining the passenger door in at least one door check position between the fully closed and open positions. Although known door check features functions as desired, they require additional space and come with additional complexities and costs associated with the additional space required, as well as added cost associated with manufacture and assembly.

In view of the above, there remains a need to develop power closure member actuation systems which address and overcome limitations and drawbacks associated with known power closure member actuation systems, particularly with regard to door check features, as well as to provide increased convenience and enhanced operational capabilities.

### SUMMARY

This section provides a general summary of the disclosure, and is not a comprehensive disclosure of its full scope or all of its features.

It is an objective of the present disclosure to provide a powered actuator for a closure of a vehicle that releasably holds a closure in a predetermined “hold position” between a closed position and an open position.

In accordance with an aspect of the disclosure, the powered actuator includes an electric motor configured to rotate a driven shaft. A linear actuator is configured to be coupled to one of a body or the closure of the vehicle for moving the closure between a fully closed position and a fully open position. The linear actuator having an extensible member and a nut configured for relative translation with one another. A cover is provided for enclosing the extensible member. A gearbox is configured apply a force to the linear actuator to move one of the extensible member or nut linearly from a first position, corresponding to the fully closed position, to a second position, corresponding to the fully open position, in response to rotation of the driven shaft. At least one friction feature is fixed to one of the extensible member or nut, and at least one fixed friction feature is fixed to the cover, wherein the at least one friction feature contacts the at least one fixed feature to releasably hold the closure between the fully closed position and the fully open position.

In accordance with another aspect of the disclosure, a powered actuator for a closure panel of a vehicle includes an electric motor configured to rotate a driven shaft and a linear actuator configured to be coupled to one of a body or the closure panel for moving the closure panel between a fully closed position and a fully open position in response to actuation of the electric motor. The linear actuator has an extensible member and a nut. A cover encloses at least a portion of the extensible member and the nut. A stop feature is fixed to at least one of the extensible member and the nut, and at least one friction feature is fixed to the cover. While moving the door between the fully closed and fully open positions, the stop feature contacts the at least one friction feature to releasably hold the closure panel between the fully closed position and the fully open position.

In accordance with another aspect of the disclosure, the stop feature is moveable along a first axis of the extensible member.

In accordance with another aspect of the disclosure, the stop feature is fixed to the extensible member for conjoint movement with the extensible member along the first axis.

In accordance with another aspect of the disclosure, the stop feature is fixed to an end of the extensible member.

In accordance with another aspect of the disclosure, the extensible member is a leadscrew.

In accordance with another aspect of the disclosure, the at least one friction feature has a pocket sized for receipt of the stop feature therein to releasably hold the closure panel between the fully closed position and the fully open position.

In accordance with another aspect of the disclosure, the pocket is annular.

In accordance with another aspect of the disclosure, the at least one friction feature is a resilient polymeric material.

In accordance with another aspect of the disclosure, a gearbox is configured to apply a force to the linear actuator to move one of the extensible member or nut linearly from a first position, corresponding to the fully closed position, to a second position, corresponding to the fully open position, in response to rotation of the driven shaft.

In accordance with another aspect of the disclosure, the stop feature is fixed to the nut for conjoint movement with the nut in response to rotation of a leadscrew of the linear actuator about the first axis.

In accordance with another aspect of the disclosure, the stop feature is fixed to the extensible member for conjoint movement with the extensible member along a second axis.

In accordance with another aspect of the disclosure, the stop feature is formed at an end of a fastener coupling the extensible member to the nut.

In accordance with another aspect of the disclosure, the extensible member is coupled to the closure panel for moving the closure panel between the fully closed position and the fully open position in response to the nut translating along the leadscrew.

In accordance with another aspect of the disclosure, the first axis of the leadscrew and the second axis of the extensible member are substantially parallel.

In accordance with another aspect of the disclosure, the at least one friction feature has a pocket sized for receipt of the stop feature therein to releasably hold the closure panel between the fully closed position and the fully open position.

In accordance with another aspect of the disclosure, the at least one friction feature includes a plurality of friction features spaced axially from one another relative to the second axis.

In accordance with another aspect of the disclosure, a method of moving and releasably holding a closure panel of a vehicle between a fully closed position of the closure panel and a fully open position of the closure panel includes: moving the closure panel to an open position, whereat a plurality of friction features are not in engaged alignment with one another; applying power to a power actuator to hold the closure panel in a desired position; activating a timer immediately after holding the closure panel in the desired position, and after a preset amount of time lapses, assessing which direction and distance to move the closure panel to a nearest mechanical detent position, and then, applying power to a power actuator and bringing a pair of the plurality of friction features into aligned engagement with one another, and then, cutting power to the power actuator.

In accordance with another aspect of the disclosure, the method can further include, after assessing which direction and distance to move the closure panel to the nearest mechanical detent position, verifying whether the closure panel can be moved to the nearest mechanical detent position without impacting an obstacle.

In accordance with another aspect of the disclosure, the method can further include, after verifying whether the closure panel can be moved to the nearest mechanical detent position without impacting an obstacle, and upon detecting an obstacle not allowing the closure panel to be moved to the nearest mechanical detent position, moving the closure panel to the next nearest available mechanical detent position without possibility of impacting an obstacle.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an example motor vehicle equipped with a power closure member actuation system situated between the front passenger swing door and a vehicle body, according to aspects of the disclosure;

FIG. 2 is a perspective inner side view of a closure member shown in FIG. 1, with various components removed for clarity purposes only, in relation to a portion of the vehicle body and which is equipped with the power closure member actuation system, according to aspects of the disclosure;

FIG. 3A illustrates a block diagram of the power closure member actuation system, according to aspects of the disclosure;

FIG. 3B illustrates a method of control of the power closure member actuation system, according to further aspects of the disclosure;

FIG. 4 illustrates another block diagram of the power closure member actuation system for moving the closure member in an automatic mode, according to aspects of the disclosure;

FIG. 5 illustrates the power closure member actuation system shown as part of a vehicle system architecture, according to aspects of the disclosure;

FIG. 6 illustrates another block diagram of the power closure member actuation system for moving the closure member in a powered assist mode, according to aspects of the disclosure;

FIG. 7 illustrates a partially cross-sectioned view of a powered actuator according to aspects of the disclosure;

FIG. 8 is a fragmentary, enlarged cross-sectional view taken along a central longitudinal axis of a leadscrew and cover of the power actuator of FIG. 7 illustrating friction features in accordance with an aspect of the disclosure;

FIG. 9 illustrates a perspective view of a powered actuator according to further aspects of the disclosure;

FIG. 10 is a cross-sectional view taken along a central longitudinal axis of a leadscrew and cover of the power actuator of FIG. 9 illustrating friction features (also referred to as detent features) in accordance with an aspect of the disclosure;

FIG. 11 is an enlarged, fragmentary view of FIG. 10 illustrating one of the friction features being engaged with a feature associated with a nut to maintain the nut in releasably fixed relation with the leadscrew along which the nut translates as the closure moves between closed and open positions; and

FIG. 12 is a flow diagram illustrating a method of moving a closure between closed and open positions and into engagement or proximity with friction features via a power actuator constructed in accordance with the disclosure.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

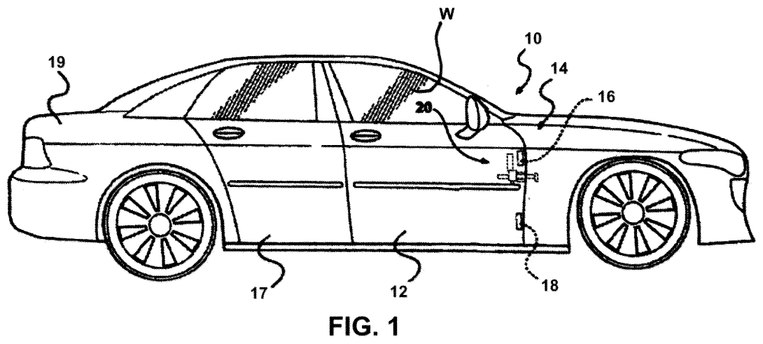

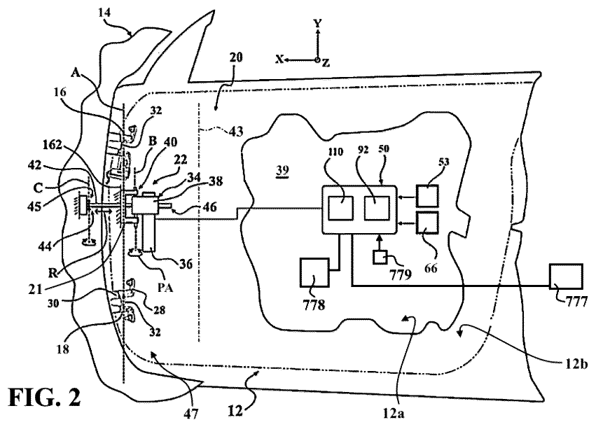

Referring initially to FIG. 1, an example motor vehicle 10 is shown to include a closure, also referred to as closure member, closure panel, and shown as a first passenger door 12, pivotally mounted to a vehicle body 14 via an upper door hinge 16 and a lower door hinge 18 which are shown in phantom lines. In accordance with one aspect of the present disclosure, a power closure member actuation system 20 is integrated into the pivotal connection between first passenger door 12 and a vehicle body 14. In accordance with a preferred configuration, power closure member actuation system 20 generally includes a power-operated actuator mechanism, also referred to as power actuator or actuator 22 (FIG. 2), secured within an internal cavity of passenger door 12, and a rotary drive mechanism that is driven by the power-operated actuator mechanism 22 and is drivingly coupled to a hinge component associated with lower door hinge 18. Driven rotation of the rotary drive mechanism causes controlled pivotal movement of passenger door 12 relative to vehicle body 14. In accordance with this preferred configuration, the power-operated actuator mechanism 22 is rigidly coupled in close proximity to a door-mounted hinge component of upper door hinge 16 while the rotary drive mechanism is coupled to a vehicle-mounted hinge component of lower door hinge 18. However, those skilled in the art will recognize that alternative packaging configurations for power closure member actuation system 20 are available to accommodate available packaging space. One such alternative packaging configuration may include mounting the power-operated actuator mechanism to vehicle body 14 and drivingly interconnecting the rotary drive mechanism to a door-mounted hinge component associated with one of upper door hinge 16 and lower door hinge 18.

Power closure member actuation system 20 is generally shown in FIG. 2 and, as mentioned, is operable for controllably pivoting vehicle door 12 relative to vehicle body 14 between a fully open position and a closed position. As shown in FIG. 2, lower hinge 18 of power closure member actuation system 20 includes a door hinge strap 28 connected to vehicle door 12 and a body hinge strap 30 connected to vehicle body 14. Door hinge strap 28 and body hinge strap 30 of lower door hinge 18 are interconnected along a generally vertically-aligned pivot axis A via a hinge pin 32 to establish the pivotable interconnection between door hinge strap 28 and body hinge strap 30. However, any other mechanism or device can be used to establish the pivotable interconnection between door hinge strap 28 and body hinge strap 30 without departing from the scope of the subject disclosure.

As best shown in FIG. 2, power closure member actuation system 20 includes the power-operated actuator mechanism 22 having a motor and geartrain assembly 34 that is rigidly connectable to vehicle door 12. Illustratively, the power closure member actuation system 20 is pivotally connected to the shut face 162 of the vehicle door 12. Motor and geartrain assembly 34 is configured to generate a rotational force about pivot axis A. In the preferred embodiment, motor and geartrain assembly 34 includes an electric motor 36 that is operatively coupled to a speed reducing/torque multiplying assembly, also referred to as geartrain assembly or gearbox 38, having one or more stages with a gear ratio allowing motor 36 and geartrain assembly 38 to generate a rotational force having a high torque output by way of a very low rotational speed of electric motor 36. However, any other arrangement of motor and geartrain assembly 34 can be used to establish the required rotational force without departing from the scope of the subject disclosure. Electrical motor 36 is controlled by electronics shown illustratively as a controller at block 50 in FIG. 2, which may includes a microprocessor 110 and power electronics 92, such as H-bridge, FETS for example, controlled by the microprocessor 110. Controller 50 is electrically connected to command sources such as a door open or close switch 53, or to another controller 66 such as a Body Control Module, or an authentication controller such as PKE controller for example. Controller 50 may be illustratively a haptic or servo controller such as described in US20220243521A1, which is incorporated herein by reference in its entirety. Controller 50 may be supplied with power from a main vehicle power source 777 when this power source 777 is available, and may be supplied with power from a backup power source 778 when the main vehicle power source 777 is not available, such as during a power failure, or a crash, or malfunction in power supply lines/wiring. Controller 50 may also be connected to a inclination sensor 779 to obtain an inclination/roll/pitch of the closure panel 12.

Motor and geartrain assembly 34 includes a mounting bracket 40 for establishing the connectable relationship with vehicle door 12 and the power-operated actuator mechanism 22. The connectable relationship of the power-operated actuator mechanism 22 with the vehicle door 12 via the mounting bracket 40 is illustrated as a pivotal connection to allow the power-operated actuator mechanism 22 to pivot about a pivot axis B, for example with rotations indicated as PA in FIG. 2. Mounting bracket 40 is configured to be connectable to vehicle door 12 between the upper door hinge 16 and lower hinge 18, and for example connectable to the shutface 162. Shutface 162 includes a port or aperture for allowing the drive shaft 42 to pass through the shutface 162, where such a port may be normally associated for allowing a door check link to pass therethough. As further shown in FIG. 2, this mounting of motor and geartrain assembly 34 in manners as will be described herein disposes the power-operated actuator mechanism 22 of power closure member actuation system 20 in close proximity to the pivot axis B. The mounting of motor and geartrain assembly 34 adjacent to the pivot axis B of vehicle door 12 minimizes the effect that power closure member actuation system 20 may have on a mass moment of inertia (i.e., pivot axis A) of vehicle door 12, thus improving or easing movement of vehicle door 12 between its open and closed positions. Reducing the mass of the actuator 22 and moving the mass of the actuator 22 closer to the pivot axis A reduces the mass moment of inertia of the door 14 and shifts the center of mass closer to the pivot axis C allowing for the motor 36 power and/or size to be reduced. In addition, as also shown in FIG. 2, the mounting of motor and geartrain assembly 34 closer to pivot axis A of vehicle door 12 allows power closure member actuation system 20 to be packaged in front of an A-pillar glass run channel 43 and other internal door components and sheet metal panels associated with vehicle door 12, thereby locating the power actuator 22 between the A-pillar glass run channel 43 and the shutface 162, and thus, power actuator system 20 and power actuator 22 thereof avoids any interference with an up/down movement of a glass window W and function of vehicle door 12. Put another way, power closure member actuation system 20 can be packaged in a portion 47 of an internal door cavity 39 within vehicle door 12, with internal door cavity 39 being defined between an outer door panel 12a and an inner door panel 12b, as is known, that is not being used or otherwise occupied by components associated with operation of other vehicle components, such as the window W, door handles, or latch, for example, and therefore reduces or eliminates impingement on existing hardware/mechanisms within vehicle door 12. Although power closure member actuation system 20 is illustrated as being mounted between the upper door hinge 16 and the lower hinge 18 of vehicle door 12, power closure member actuation system 20 can, as an alternative, also be mounted elsewhere within vehicle door 12 or even on vehicle body 14 without departing from the scope of the subject disclosure.

Power closure member actuation system 20 further includes the rotary drive mechanism that is rotatively driven by the power-operated actuator mechanism 22. As shown in FIG. 2, the rotary drive mechanism includes the drive shaft 42 interconnected to an output member of gearbox 38 of motor and geartrain assembly 34 and which extends and retracts from both of the opposite sides of the gearbox 38. In addition, as an optional configuration although not expressly shown, a clutch, such as a mechanical or electrical clutch, may be disposed between the rotary output of gearbox 38 and first end 44 of drive shaft 42. The clutch may engage and disengage using any suitable type of clutching mechanism such as, for example, a set of sprags, rollers, a wrap-spring, friction plates, or any other suitable mechanism. The clutch may be provided to permit door 12 to be manually moved by the user between its open and closed positions relative to vehicle body 14. Such a clutch could, for example, also be located between the output of electric motor 36 and the input to gearbox 38. The location of this optional clutch may be dependent based on, among other things, whether or not gearbox 38 includes back-drivable gearing. In another possible configuration the power closure member actuation system 20 may not be provided with a clutch, which as a result reduces the mass of the power closure member actuation system 20 and of the door 14. Possibly the gearbox 38 may include “back-drivable” gearing to allow a user to manually move the door 14 whereby the gearing of the gearbox 38 will be induced to rotate. Possibly the gearbox 38 may alternatively include non-back-drivable preventing a user to manually move the door 14 whereby the gearing of the gearbox 38 cannot be induced to rotate by movement of the door 12, but rather only an activation of the motor 22 will cause the gearing of gearbox 38 to rotate to move the door 12. A brake mechanism which prevents anyone of the rotation of the motor 36, the gearbox 38, or movement of the drive shaft 42 may also be omitted and not provided with the power closure member actuation system 20 to further reduce mass of the power closure member actuation system 20 and the door 12.

To accommodate angular motion due to swinging movement of door 12 relative to vehicle body 14, the power closure member actuation system 20 further includes a pivotal connection 45 disposed between the vehicle body 14 and the first end 44 of drive shaft 42. Second end 46 of drive shaft 42 is configured to reciprocate into and out of cavity 39 as drive shaft 42 is driven by the gearbox 38 in response to actuation of motor 36. Illustratively, connection 45 is a pin and socket type connection allowing pivotal rotation/oscillation of the drive shaft 42 about an axis C, which extends parallel or substantially parallel to the generally vertical pivot axis A of the door 14 and parallel or substantially parallel to the pivot axis B of the power-operated actuator mechanism 22. Translation of drive shaft 42 via operation of motor and geartrain assembly 34 functions to push the door 12 away from the vehicle body 14 when the drive shaft 42 is retracted outwardly from the cavity 39 and to pull the door 12 towards the vehicle body 14 when the drive shaft 42 is translated inwardly into the cavity 39. As a result, power closure member actuation system 20 is able to effectuate movement of vehicle door 12 between its open and closed positions by “directly” transferring a rotational force to the vehicle body 14 via linear translation of the driven drive shaft 42 in the illustrated example of FIG. 2. With motor and geartrain assembly 34 connected to vehicle door 12 adjacent to the shut face 162, second end 46 of drive shaft 42 may reciprocate and swing pivotably within cavity 39 as driven shaft 42 reciprocates R within and through gearbox 38. Based on available space within door cavity 39, second end 46 of drive shaft 42 may avoid collision with internal components within cavity 49 and with the outer and inner door panels 12a, 12b as the power-operated actuator mechanism 22 swings about axis B since, for example, the drive shaft 42 is retracted outwardly from the cavity 39 as the door 12 is opened.

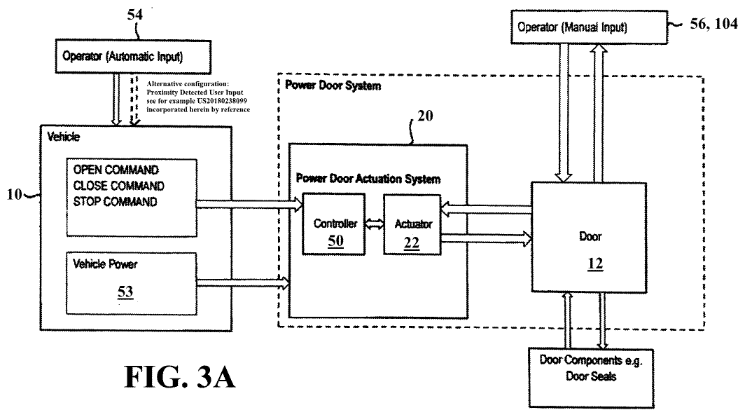

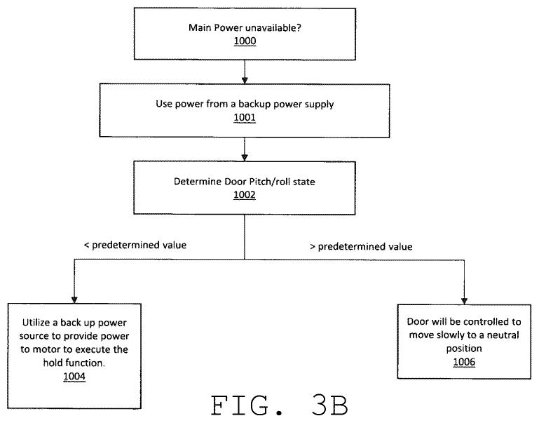

Now referring to FIG. 3B, controller 50 may be configured at step 1000 to determine if a main vehicle power supply 777 is available. If power is not available, in step 1001 the controller 50 uses and/or controls the electric motor 22 using power supplied form a backup power source 778. Controller in step 1002 determine the inclination/pitch/roll of the door 12 for example using a sensor signal, such as inclination sensor 779 to determine if the electric motor 22 is to be controlled to hold open the door 12 using power from the backup power source 778 if the door inclination/pitch/roll is below a predetermined angle. If the controller 50 determines to determine the door inclination/pitch/roll is above a predetermined angle the electric motor 22 is be controlled to move the door to a neutral (i.e. door open or door close position or to a position where the door is not moved under the influence of gravity) position using power from the backup power source 778

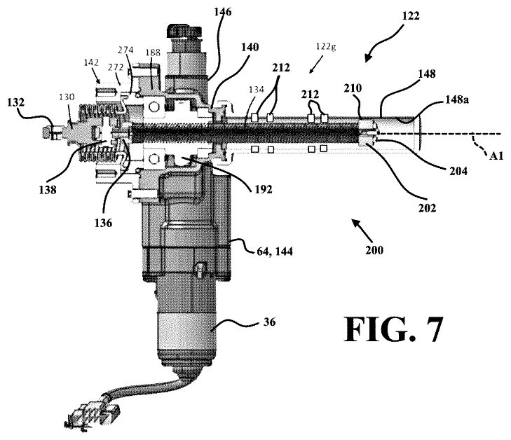

Power closure member actuation system 20, as mentioned above, further includes a rotary drive mechanism that is supported via a pivotal hinge coupling 21 to the shut face 162 and is rotatively driven by the power-operated actuator mechanism 22. As shown in FIG. 7, the rotary drive mechanism includes the motor 36 driving a nut 192 for causing extension and retraction of drive shaft, also referred to as extensible member identified by reference numeral 134, corresponding with reference numeral 42 in FIG. 2, which is coupled at one of its ends to the vehicle body 14. Operation and construction of one example power-operated actuator mechanism 22 is shown and described in US20230265704A1, the entire contents of which is incorporated herein by reference.

As a result, power closure member actuation system 20 is able to effectuate movement of vehicle door 12 between its open and closed positions by “directly” transferring a rotational force of the motor 36 to the extension and retraction of extensible member 134.

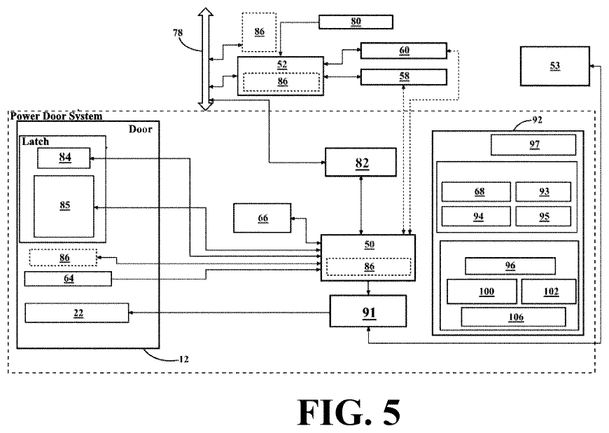

FIG. 3A illustrates a block diagram of the power closure member actuation system 20 for moving the closure member (e.g., vehicle door 12 or 17) of the vehicle 10 in between open and closed positions relative to the vehicle body 14. As discussed above, the power closure member actuation system 20 includes the actuator 22 that is coupled to the closure member/panel (e.g., vehicle door 12) and the vehicle body 14. The actuator 22 is configured to move the closure member 12 relative to the vehicle body 14 between opened and closed positions. The power closure member actuation system 20 also includes the controller 50, as discussed above, that is operably coupled in communication with the actuator 22 and in communication with other vehicle systems (e.g., a body control module 52) and also receives vehicle power from the vehicle 10 (e.g., from a vehicle battery 53, shown in FIG. 5). The controller 50 is operable in at least one of an automatic mode (in response to an automatic mode initiation input 54) and a powered assist mode (in response to a motion input 56). In the automatic mode, the controller 50 commands movement of the closure member 12 through a predetermined motion profile (e.g., to open the closure member 12). The powered assist mode is different than the automatic mode in that the motion input 56 from the user may be continuous to move the closure member 12, as opposed to a singular input by the user in automatic mode. Commands from the other vehicle systems may, for example, include instructions the controller 50 to open the closure member 12, close the closure member 12, or stop motion of the closure member 12 (e.g., in the automatic mode). Also shown are other components that may have an impact on the operation of the power closure member actuation system 20, such as door seals of the vehicle door 12, for example.

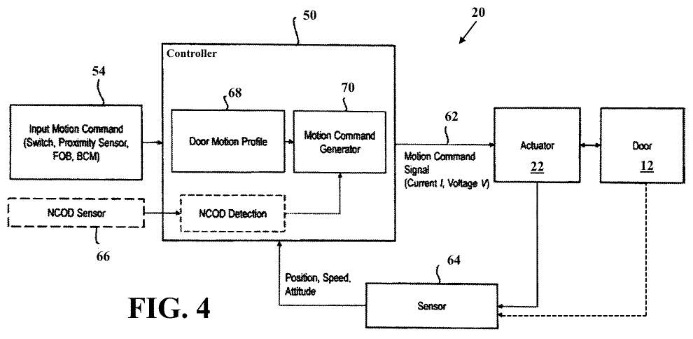

Referring now to FIG. 4, the controller 50 is configured to receive the automatic mode initiation input 54 and enter the automatic mode to output a motion command 62 in response to receiving the automatic mode initiation input 54. The automatic mode initiation input 54 can be a manual input on the closure member itself or an indirect input to the vehicle 10 (e.g., closure member switch 58 on the closure member, switch on a key fob 60, etc.). So, the automatic mode initiation input 54 may, for example, be a result of a user or operator operating a switch (e.g., the closure member switch 58), making a gesture near the vehicle 10, or possessing a key fob 60 near the vehicle 10. It should also be appreciated that other automatic mode initiation inputs 54 are contemplated, such as, but not limited to a proximity of the user detected by a proximity sensor.

In addition, the power closure member actuation system 20 includes at least one closure member feedback sensor 64 for determining at least one of a position and a speed of the closure member. Thus, the at least one closure member feedback sensor 64 detects signals from either the actuator 22 by counting revolutions of the electric motor 36, absolute position of an extensible member (not shown), or from the door 12 (e.g., an absolute position sensor on a door check as an example) can provide position information to the controller 50.

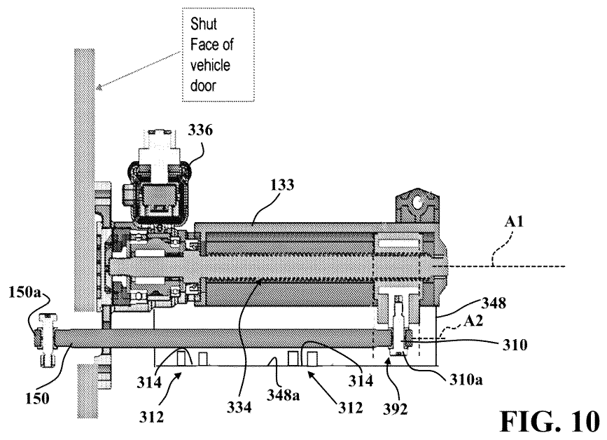

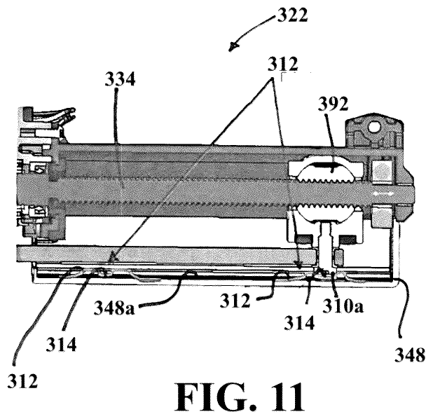

The power closure member actuation system 20 additionally includes at least one non-contact obstacle detection sensor 66 coupled to the controller 50. The controller 50 is configured to determine whether an obstacle is detected using the at least one non-contact obstacle detection sensor 66 and may, for example, cease movement of the closure member in response to determining that the obstacle is detected. The at least one non-contact obstacle detection sensor 66 and operation of the proximity sensor are discussed in U.S. Publication No. 2018/0238099, incorporated herein by reference. Non-contact obstacle detection sensor 66 can be utilized in conjunction with embodiments discussed in FIGS. 7-12, as would be understood by a person possessing ordinary skill in the art upon viewing the entirety of the disclosure herein.

In the automatic mode, the controller 50 can include one or more closure member motion profiles 68 that are utilized by the controller 50 when generating the motion command 62 (e.g., using a motion command generator 70 of the controller 50) in view of the obstacle detection by the at least one non-contact obstacle detection sensor 66. So, in the automatic mode, the motion command 62 has a specified motion profile 68 (e.g., acceleration curve, velocity curve, deceleration curve, and stop position) so as to control the movement of the closure member 12 in a predetermined manner, for example, by controlling the movement of the closure member 12 at a constant speed.

In FIG. 5, the power closure member actuation system 20 is shown as part of a vehicle system architecture 72 operable in the automatic mode and the powered assist mode. The body control module 52 is in communication with the controller 50 via a vehicle bus 78 (e.g., a Local Interconnect Network or LIN bus). The body control module 52 can also be in communication with the key fob 60 (e.g., wirelessly) and a closure member switch 58 configured to output a closure member trigger signal through the body control module 52. Alternatively, the closure member switch 58 could be connected directly to the controller 50 or otherwise communicated to the controller 50. The body control module 52 may also be in communication with at least one environmental sensor 80. Specifically, the at least one environmental sensor can be a temperature sensor 80.

The controller 50 can be coupled to a closure communications interface control unit 82 which connects to the vehicle bus 78. In other words, the closure communication interface control unit 82 facilitates communication between the controller 50 and the vehicle bus 78. The controller is also coupled with a latch 83 that includes a cinch motor 84 (for cinching the closure member 12 into the closed position). The latch 83 also includes a plurality of primary and secondary ratchet position sensors or switches 85 that provide feedback to the controller 50 regarding whether the latch 83 is in a primary latched position or a secondary latched position, for example.

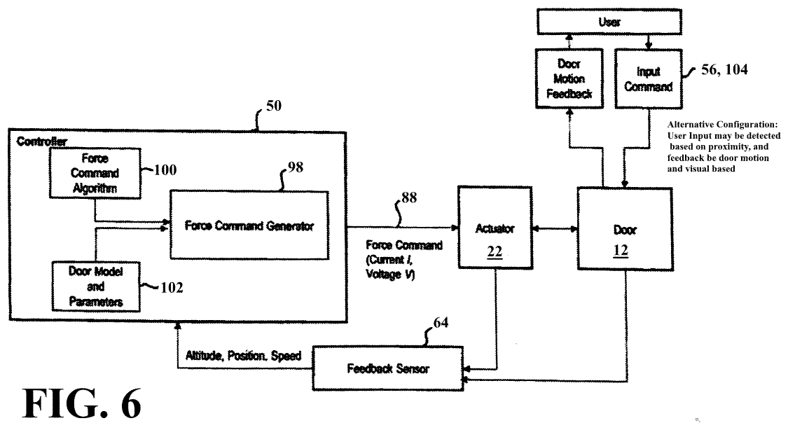

A vehicle inclination sensor 86 (such as an accelerometer) is also coupled to the controller 50 for detecting an inclination of the vehicle 10. The vehicle inclination sensor 86 outputs an inclination signal corresponding to the inclination of the vehicle 10 and the controller 50 is further configured to receive the inclination signal and adjust the one of a force command 88 (FIG. 6) and the motion command 62 accordingly. While the vehicle inclination sensor 86 may be separate from the controller 50, it should be understood that the vehicle inclination sensor 86 may also be integrated in the controller 50, in the closure member (e.g., door 12 or 17), or in another control module, such as, but not limited to the body control module 52.

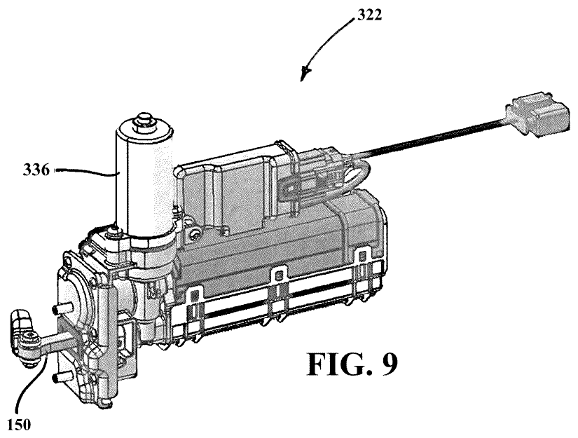

A pulse width modulation unit 91 is also coupled to the controller 50 and is configured to receive a pulse width control signal and output an actuator command signal corresponding to the pulse width control signal. The controller 50 includes a processor or other computing unit 110 in communication with the memory device 92. So, the controller 50 is coupled to a memory device 92 for storing a plurality of automatic closure member motion parameters 68, 93, 94, 95 for the automatic mode and a plurality of powered closure member motion parameters 96, 100, 102, 106 for the powered assist mode and used by the controller 50 for controlling the movement of the closure member (e.g., door 12 or 17). Specifically, the plurality of automatic closure member motion parameters 68, 93, 94, 95 includes at least one of closure member motion profiles 68 (e.g., plurality of closure member velocity and acceleration profiles), a plurality of closure member stop positions 93 (e.g., see FIG. 9), a closure member check sensitivity 94, and a plurality of closure member check profiles 95. The plurality of powered closure member motion parameters 96, 100, 102, 106 includes at least one of a plurality of fixed closure member model parameters 96 and a force command generator algorithm 100 and a closure member model 102 and a plurality of closure member component profiles 106. In addition, the memory device 92 stores a date and mileage and cycle count 97. The memory device 92 may also store boundary conditions (e.g., plurality of predetermined operating limits) used for a boundary check to prevent movement of the closure member and operation of the actuator 22 outside a plurality of predetermined operating limits or boundary conditions.

As best shown in FIG. 6, the controller 50 is also configured to receive the motion input 56 and enter the powered assist mode to output the force command 88 (e.g., using a force command generator 98 of the controller 50 as a function of the force command algorithm 101, closure member model 102, and plurality of closure member component profiles 106). The controller 50 is also configured to generate the force command 88 using the at least one environmental condition to control an actuator output force acting on the closure member 12 to move the closure member 12. So, the controller 50 varies an actuator output force acting on the closure member 12 to move the closure member in response to receiving the motion input 56. In the powered assist mode, the force command 88 has a specified force profile (e.g., that may be altered to based on changes in the environmental condition, such as by increasing or decreasing the force assist provided to the user). A user movement sensor 104 is coupled to the controller 50 and is configured to sense the motion input 56 from the user on the closure member 12 to move the closure member 12. Again, the power closure member actuation system 20 further includes at least one closure member feedback sensor 64 for determining at least one of a position and speed of the closure member 12. The at least one closure member feedback sensor 64 detects the position and/or speed of the closure member 12, as described above for the automatic mode, and can provide corresponding position/motion information or signals to the controller 50 concerning how the user is interacting with the closure member 12 during powered assist mode. For example, the at least one closure member feedback sensor 64 determine how fast the user is moving the closure member (e.g., door 12 or 17). The attitude or inclination sensor 86 may also determine the angle or inclination of the closure member 12 and the power closure member actuation system 20 may compensate for such an angle to assist the user and negate any effects on the closure member motion that the change in angle causes (e.g., for example changes regarding how gravity may influence the closure member differently based on the angle of the closure member relative to a ground plane).

Referring now to FIG. 7, a first powered actuator, also referred to as linear actuator assembly, linear actuator or actuator 122, constructed in accordance with an aspect of the disclosure is disclosed. It is to be understood that the aspects discussed here for actuator 122 can be incorporated into actuator 22 of FIG. 2, and vice versa. The actuator 122 includes a link bar 130 defining a distal hole 132. The distal hole 132 is configured to be connected to the vehicle body 14 in some embodiments where the powered actuator 122 is disposed within the closure, for example as shown in FIG. 2. Alternatively, the distal hole 132 may be configured to be connected to the closure, such as a vehicle side door 12, 17 in embodiments where the first powered actuator is disposed outside of the closure, for example within a structure of the vehicle body 14. The link bar 130 is connected to an extensible member 134, referred to as drive shaft above, via a linkage 136 having a pin 138 pivotably supporting the link bar 130. Thus, the extensible member 134 is configured to be coupled to the vehicle body 14 or the closure 12 of the vehicle for opening or closing the closure 12.

The powered actuator 122 also includes a gearbox 140 configured apply a force from the linear actuator 122 via the extensible member 134 for causing the extensible member 134 to move linearly relative to and through the fixed nut 192 to move passenger door 12 between the closed and open positions. An adapter 142 is configured to mount the gearbox 140 to the closure 12 or to the vehicle body 14. An electric motor 36 is drivingly coupled to the gearbox 140 for operably driving the powered actuator 122. The electric motor 36 may be a standard DC motor such as a permanent magnet (e.g. ferrite) or a reluctance type motor. The electric motor 36 may be a brushless DC (BLDC) type motor such as a permanent magnet (e.g. ferrite) or a reluctance type motor. A closure member feedback sensor 64 in the form of a high-resolution position sensor 144 is disposed between the electric motor 36 and the gearbox 140. The high-resolution position sensor 144 may include a magnet wheel and a Hall effect sensor to provide speed, direction, and/or positional information regarding the extensible member 134 and the closure 12 attached thereto. An electromagnetic (EM) brake 146 can be coupled to the gearbox 140 on an opposite side from the electric motor 36. The EM brake 146 is optional and may not be included in all powered actuators. A cover 148 is attached to the gearbox 140 and is configured to enclose the extensible member 134. The cover 148 may help to prevent dust or dirt from fouling the extensible member 134 and/or to protect the extensible member 134 from contacting other components within the closure or the vehicle body 14. The cover 148 is formed as a hollow cylindrical tube, as shown on FIG. 7.

In some embodiments, and as shown in the powered actuator 122 of FIG. 7, the extensible member 134 includes a leadscrew having one or more helical threads extending thereabout. The extensible member 134 may have other configurations. Extensible member 134 can be configured to translate in threaded engagement with fixed lead nut 192, such as fixed in a torque tube. The torque tube is held within the gearbox housing 188 in any suitable fashion.

The powered actuator 122 includes a mechanical check mechanism 200 includes a hard stop feature, also referred to as friction feature, stop feature or travel limiter 210, disposed on an axial end of the extensible member 134 opposite (i.e. farthest away from) the linkage 136. The travel limiter 210 is configured for limiting axial extension of the extensible member 134. Specifically, the travel limiter 210 functions as a hard stop feature, shown in a non-limiting embodiment including a bumper 202 of resilient material, such as rubber, having a toroid or tubular shape extending around the extensible member 134 adjacent the axial end thereof. A retainer clip 204 fastened directly to the extensible member 134 holds and retains the bumper 202 in a fixed location on the axial end of the extensible member 134. The retainer clip 204 may include any suitable hardware including, for example, a washer, a nut, a cotter pin, an E-Clip, or a C-clip, such as a snap ring.

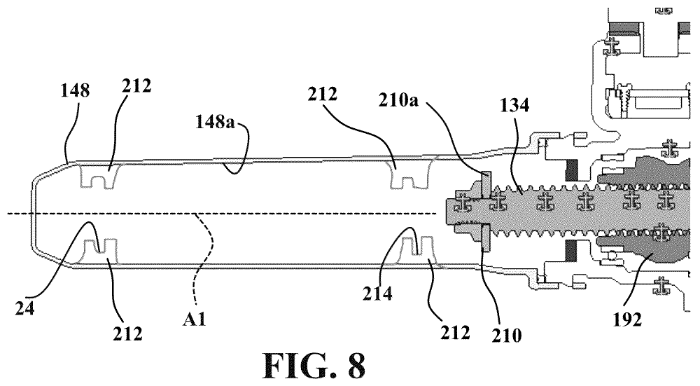

To facilitate releasably holding the passenger door 12 in a desired door stop position between the fully open and closed positions, such as in a desired door check position, the mechanical check mechanism 200 is provided further including at least one friction feature 212 fixed to one of the extensible member 134 or cover 148, and shown as being fixed to an inner surface 148a of the cover 148 in FIGS. 7 and 8, by way of example and without limitation. The at least one friction feature 212 is configured to mechanically interact with the hard stop feature 210 at the desired door stop positions, and can be configured to contact the extensible member 134, if desired, such that friction between the extensible member 134 and fixed friction feature 212 functions to releasably hold the closure 12 at an infinite number of positions between the fully closed position and the fully open position upon motor 36 being de-energized. The at least one friction feature 212 is shown as a pair of friction features 212 spaced axially along a longitudinal first axis A1 of the extensible member 134 along which the extensible member 134 translates during use, by way of example and without limitation. The friction features 212 can be provided as deformable friction features, such as being resilient and elastically deformable, by way of example and without limitation.

The material, such as a resilient and elastically deformable polymeric, rubber or plastic material, by way of example and without limitation, and shape of hard stop feature and friction features 210, 212 can be provided and tuned relative to one another to result in a predetermined magnitude of friction to provide the desired “hold force” that is repeatable in use over a long life and over a large temperature range, thereby not losing effectiveness over a long duty cycle (projected life of the vehicle) from a hot climate to a cold climate. The precise locations of the friction features 212 along the longitudinal first axis A1 within the cover 148 can be predetermined in manufacture to result in one or more “door check positions”, such as an intermediate door open position and a fully open, or slightly less than fully open door position, such as between about 5-10 degrees less than fully open, as provided by many traditional door check systems. The friction features 212 can be formed having detents, shown as pockets, including annular or semi-annular pockets 214, by way of example and without limitation, formed in a radially inwardly facing surface facing the first axis A1 and configured to interact and releasably capture an outer periphery 210a of the hard stop feature 210. Thus, when the outer periphery 210a is disposed within one of the pockets 214, the hard stop feature 210 and respective friction feature 212 interact with one another to provide the door check function to releasably maintain the passenger door 12 in the desired position, until desired to intentionally release the hard stop feature 210 from captured engagement with the friction feature 210, whether under power by the powered actuator 122 or under mechanical, manual force by a user.

With the mechanically functioning and hard stop feature and friction features 210, 212 provided and contained within the linear actuator 122, separate space outside that occupied by the linear actuator 122 is not needed for a separate door check mechanism, and thus, great space savings are recognized, which lends to enhanced options for door design and reduction of costs associated therewith. It is to be recognized that the friction features 212 can be incorporated into a motorless linear actuator, if desired. The friction features 212 can be provided as resilient static members, or a dynamic member(s), such as via a ball detent mechanism having a moveable ball biased by a spring member, as will be understood by a person possessing ordinary skill in the art upon viewing the disclosure herein.

In FIGS. 9 through 11, a second powered actuator, also referred to as linear actuator assembly, linear actuator or actuator 322, constructed in accordance with an aspect of the disclosure is disclosed, wherein like features are identified by the same reference numerals as used for actuator 122, offset by a factor of 300. It is to be understood that the aspects discussed here for actuator 322 can be incorporated into actuator 22 of FIG. 2. In contrast to the actuator 122 of FIGS. 7 and 8, at least one moveable friction feature, also referred to as hard stop feature or stop feature 310, is fixed to a nut 392 and at least one fixed friction feature 312 is fixed to an inner surface 348a of a cover 348, wherein the at least one moveable friction feature 310 contacts the at least one fixed friction feature 312 to releasably hold the closure, such as passenger door 12, between the fully closed position and the fully open position. Other configurations are possible, such as the at least one fixed friction feature 312 positioned on housing 133 or gearbox 140 for example. In the illustrated non-limiting embodiment, the at least one moveable friction feature 310 is provided by a head 310a of a fastener used to couple and fix an extensible member, also referred to as drive member or drive rod 150, to nut 392 for fixed translation of moveable friction feature 310 in conjoint relation with nut 392 and extensible member 150 as nut 392 translates along an elongate member 334, such as a leadscrew, as elongate member 334 is rotatably driven by a motor 336. The friction features 312 can be formed having detents, shown as troughs or pockets 314 extending transversely to a first axis A1, by way of example and without limitation, formed in a radially inwardly facing surface 348a of cover 348 facing the first axis A1 and configured to interact and releasably capture an end 310a of the hard stop feature 310. The size and length of the end 310a and size of the pockets 314, including depth of the pockets 314, can be tuned relative to one another to provide the desired amount of axially extending force required to remove the end 310a from pockets 314, as will be readily understood by a person possessing ordinary skill in the art upon viewing the disclosure herein. Accordingly, depending on the door application, including weight specifications of the door 12, the door stop functionality provided by hard stop feature 310 and friction features 312 can be tuned to accommodate the door specifications. An end 150a of drive rod 150 can be connected to the vehicle body 14 in some embodiments where the powered actuator 322 is disposed within the closure 12, for example as shown in FIG. 2, by way of example and without limitation. Drive rod 150 extends in generally parallel relation with leadscrew 334 such that drive rod 150 is driven along a second axis A2 that is generally or substantially (intending to mean true parallel or between about 0-10 degrees off true parallel) parallel to first axis A1 of leadscrew 334 as nut 392 translates relative to leadscrew 334 along first axis A1. The door stop functionality of provided at each location of friction features 312 as the hard stop feature 310 enters the pocket 314 thereof. In the embodiment illustrated, the at least one friction feature 312 includes a plurality, and more particularly, a pair of friction features 312 spaced axially from one another relative to the second axis A2 to provide multiple door stop positions, such as an intermediate door stop position, whereat door 12 is between the closed and fully open positions, and a fully open door stop position, whereat door 12 is in the fully open position.

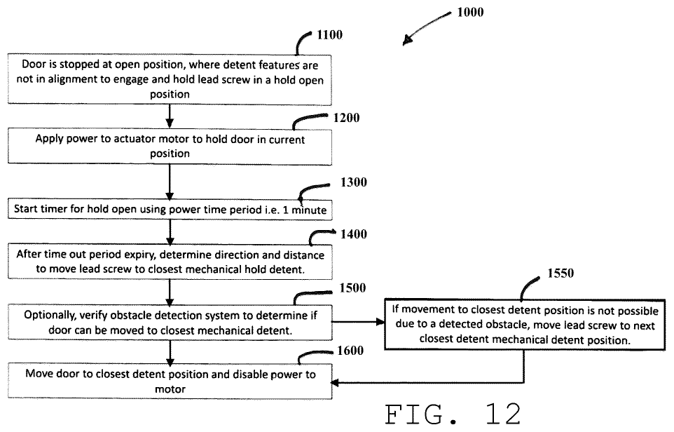

In FIG. 12, a flow diagram illustrating a method 1000 of moving a closure 12 between closed and open positions and into engagement or proximity with friction features, 210, 212; 310, 312, via a power actuator 122, 322 constructed in accordance with the disclosure. In step 1100, after moving the door 12 via power actuator 122, 322, the door 12 can be stopped via the power actuator 122, 322 or via a user at an open position, where the respective friction features 210, 212; 310, 312 are not in engaged alignment with one another, thereby not holding the door 12 in a releasably stable position. Then, at step 1200, power can be applied to the power actuator 122, 322 to hold the door 12 in the currently desired position. Then, in step 1300, immediately after step 1200, a timer can be started via controller 50, 66, by way of example and without limitation, and then, after a preset amount of time lapses, such as 1 minute, for example, at step 1400, position sensors in communication with controller 50, 66, such as the at least one closure member feedback sensor 64, can assess which direction and distance to move leadscrew and door 12 to the nearest mechanical detent position, whereat the respective friction features 210, 212; 310, 312 are brought into aligned engagement with one another, thereby functioning as a door stop to releasably maintain door 12 in the desired position. Optionally, in combination with step 1400, at step 1500, verification of an obstacle, or lack thereof, can be determined via obstacle detection system including at least one non-contact obstacle detection sensor 66 coupled to the controller 50, 66 to ensure door 12 can be moved to the nearest mechanical detent position without impacting an obstacle. Then, at step 1550, if movement of door 12 to the nearest detent position is not possible due to the detection of an obstacle, controller 50, 66 can assess which direction and distance to move leadscrew and door 12 to the next nearest mechanical detent position without impacting an obstacle, whereat the respective friction features 210, 212; 310, 312 are brought into aligned engagement with one another. Then, at step 1600, either directly after step 1500 or step 1550, actuating the power actuator 122, 322 and moving the door 12 to the nearest available door stop position without possibility of impacting an obstacle, as optionally verified by at least one non-contact obstacle detection sensor 66, whereat the respective friction features 210, 212; 310, 312 are brought into aligned engagement with one another, without impacting an obstacle, and then cutting the power to the power actuator 122, 322.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A powered actuator for a closure panel of a vehicle, comprising:
an electric motor configured to rotate a driven shaft;
a linear actuator configured to be coupled to one of a body or the closure panel for moving the closure panel between a fully closed position and a fully open position in response to actuation of the electric motor, the linear actuator having an extensible member and a nut;
a cover enclosing at least a portion of the extensible member and the nut;
a stop feature fixed to at least one of the extensible member and the nut; and
at least one friction feature fixed to the cover,
wherein the stop feature contacts the at least one friction feature to releasably hold the closure panel between the fully closed position and the fully open position.

2. The powered actuator of claim 1, wherein the stop feature is moveable along a first axis of the extensible member.

3. The powered actuator of claim 2, wherein the stop feature is fixed to the extensible member for conjoint movement with the extensible member along the first axis.

4. The powered actuator of claim 3, wherein the stop feature is fixed to an end of the extensible member.

5. The powered actuator of claim 3, wherein the extensible member is a leadscrew.

6. The powered actuator of claim 3, wherein the at least one friction feature has a pocket sized for receipt of the stop feature therein to releasably hold the closure panel between the fully closed position and the fully open position.

7. The powered actuator of claim 6, wherein the pocket is annular.

8. The powered actuator of claim 3, wherein the at least one friction feature is a resilient polymeric material.

9. The powered actuator of claim 1, further including a gearbox configured apply a force to the linear actuator to move one of the extensible member or nut linearly from a first position, corresponding to the fully closed position, to a second position, corresponding to the fully open position, in response to rotation of the driven shaft.

10. The powered actuator of claim 2, wherein the stop feature is fixed to the nut for conjoint movement with the nut in response to rotation of a leadscrew of the linear actuator about the first axis.

11. The powered actuator of claim 10, wherein the stop feature is fixed to the extensible member for conjoint movement with the extensible member along a second axis.

12. The powered actuator of claim 11, wherein the stop feature is formed at an end of a fastener coupling the extensible member to the nut.

13. The powered actuator of claim 12, wherein the extensible member is coupled to the closure panel for moving the closure panel between the fully closed position and the fully open position in response to the nut translating along the leadscrew.

14. The powered actuator of claim 13, wherein the first axis of the leadscrew and the second axis of the extensible member are substantially parallel.

15. The powered actuator of claim 14, wherein the at least one friction feature has a pocket sized for receipt of the stop feature therein to releasably hold the closure panel between the fully closed position and the fully open position.

16. The powered actuator of claim 15, wherein the at least one friction feature includes a plurality of friction features spaced axially from one another relative to the second axis.

17. A method of moving and releasably holding a closure panel of a vehicle between a fully closed position of the closure panel and a fully open position of the closure panel, comprising:
moving the closure panel to an open position, whereat a plurality of friction features are not in engaged alignment with one another;
applying power to a power actuator to hold the closure panel in a desired position;
activating a timer immediately after holding the closure panel in the desired position, and after a preset amount of time lapses, assessing which direction and distance to move the closure panel to a nearest mechanical detent position;
applying power to a power actuator and bringing a pair of the plurality of friction features into aligned engagement with one another; and
cutting power to the power actuator.

18. The method of claim 17, further including, after assessing which direction and distance to move the closure panel to a nearest mechanical detent position, verifying whether the closure panel can be moved to the nearest mechanical detent position without impacting an obstacle.

19. The method of claim 18, further including, after verifying whether the closure panel can be moved to the nearest mechanical detent position without impacting an obstacle, and upon detecting an obstacle not allowing the closure panel to be moved to the nearest mechanical detent position, moving the closure panel to the next nearest available mechanical detent position without possibility of impacting an obstacle.
